(19) United States
(12) Patent Application Publication
(10) Pub. No.: US 2012/0138667 A1
(43) Pub. Date: Jun. 7, 2012

(54) CARTON WITH DISPENSER

(76) Inventors: Bradley J. Burke, Glendale Heights, IL (US); Karl A. Kohler, Bartlett, IL (US); Robert Wolfe, Chicago, IL (US)

(21) Appl. No.: 13/309,942

(22) Filed: Dec. 2, 2011

Related U.S. Application Data
(60) Provisional application No. 61/458,895, filed on Dec. 3, 2010.

(51) Int. Cl. B65D 5/56; B31B 1/84; B31B 7/00; B31B 1/26

(52) U.S. Cl. 229/117.3; 229/217; 229/231; 220/495.01; 493/94; 493/122; 493/162

(57) ABSTRACT

A carton for containing a product. The carton comprises a plurality of panels that extends at least partially around an interior of the carton. The plurality of panels comprises a first end panel, a first side panel, a second end panel, and a second side panel. At least one top flap can be respectively foldably connected to a respective panel of the plurality of panels. The at least one top flap comprises at least an end top flap foldably connected to the second end panel. A dispenser can comprise at least a portion of the end top flap, a tear feature extending at least partially across the end top flap, and a dispenser pattern extending in at least a portion of the end top flap and the second end panel. The dispenser can be positionable between a dispensing position and a closed position after tearing the tear feature.

### CROSS-REFERENCE TO RELATED APPLICATIONS

This application claims the benefit of U.S. Provisional Patent Application No. 61/458,895, filed Dec. 3, 2010.

### INCORPORATION BY REFERENCE

The disclosure of U.S. Provisional Patent Application No. 61/458,895, which was filed on Dec. 3, 2010, is hereby incorporated by reference for all purposes as if presented herein in its entirety.

### BACKGROUND OF THE DISCLOSURE

The present disclosure generally relates to cartons having a dispenser.

### SUMMARY OF THE DISCLOSURE

In general, one aspect of the disclosure is directed to a carton for containing a product. The carton comprises a plurality of panels that extends at least partially around an interior of the carton. The plurality of panels comprises a first end panel, a first side panel, a second end panel, and a second side panel. At least one top flap can be respectively foldably connected to a respective panel of the plurality of panels. The at least one top flap at least partially forms a closed top end of the carton, and the at least one top flap comprises at least an end top flap foldably connected to the second end panel. A dispenser can comprise at least a portion of the end top flap, a tear feature extending at least partially across the end top flap, and a dispenser pattern extending in at least a portion of the end top flap and the second end panel. The dispenser can be positionable between a dispensing position and a closed position after tearing the tear feature.

In another aspect, the disclosure is generally directed to a blank for forming a carton for containing a product. The blank can comprise a plurality of panels comprising a first end panel, a first side panel, a second end panel, and a second side panel. At least one top flap can be respectively foldably connected to a respective panel of the plurality of panels. The at least one top flap can be for at least partially forming a closed top end of the carton formed from the blank, and the at least one top flap can comprise at least an end top flap foldably connected to the second end panel. The blank can further comprise dispenser features for forming a dispenser in the carton formed from the blank. The dispenser features can comprise at least a portion of the end top flap, a tear feature extending at least partially across the end top flap, and a dispenser pattern extending in at least a portion of the end top flap and the second end panel. The dispenser can be for positioning between a dispensing position and a closed position after tearing the tear feature in the carton formed from the blank.

In another aspect, the disclosure is generally directed to a method of forming a carton. The method can comprise obtaining a blank comprising a plurality of panels. The plurality of panels can comprise a first end panel, a first side panel, a second end panel, and a second side panel. At least one top flap can be respectively foldably connected to a respective panel of the plurality of panels. The at least one top flap can comprise at least an end top flap foldably connected to the second end panel. Dispenser features can comprise at least a portion of the end top flap, a tear feature extending at least partially across the end top flap, and a dispenser pattern extending in at least a portion of the end top flap and the first end panel. The method can further comprise forming an interior of the carton at least partially defined by the plurality of panels and positioning the at least one top flap to at least partially close a top end of the interior and to at least partially form a dispenser comprising the dispenser features. The method also can comprise opening the dispenser by tearing the tear feature and positioning a reclosable lid portion of the end top flap to a dispensing position, and closing the dispenser by positioning the reclosable lid portion of the end top flap to a closed position.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is an interior plan view of a carton blank used to form a carton in accordance with a first embodiment of the disclosure.

FIG. 1A is an exterior plan view of dispenser features in the blank of FIG. 1.

FIG. 2A is a perspective view of a partially-assembled carton with an open top end in accordance with the first embodiment of the disclosure.

FIG. 2B is a perspective view of the partially-assembled carton of FIG. 2A with the top end partially closed in accordance with the first embodiment of the disclosure.

FIG. 3 is a perspective view of the assembled carton in accordance with the first embodiment of the disclosure.

FIG. 4 is a perspective view of the assembled carton of FIG. 3 in a dispensing configuration.

FIG. 5 is a top view of the carton of FIG. 4 in a closed configuration.

FIG. 6 is an interior plan view of a carton blank used to form a carton in accordance with a second embodiment of the disclosure.

FIG. 7 is a perspective view of the assembled carton in accordance with the second embodiment of the disclosure.

FIG. 8 is an interior plan view of a carton blank used to form a carton in accordance with a third embodiment of the disclosure.

FIG. 9 is an interior plan view of a carton blank used to form a carton in accordance with a fourth embodiment of the disclosure.

FIG. 10 is an interior plan view of a carton blank used to form a carton in accordance with a fifth embodiment of the disclosure.

Corresponding parts are designated by corresponding reference numbers throughout the drawings.

### DETAILED DESCRIPTION OF THE EXEMPLARY EMBODIMENTS

The present disclosure generally relates to cartons that may contain products such as powder-type mixes, granular materials, salts and other crystallines. The carton can include various dispenser features and/or various viewing or indicating features for helping to determine the level of product in the carton. In this specification, the terms “lower,” “bottom,” “upper” and “top” indicate orientations determined in relation to fully erected and upright cartons.

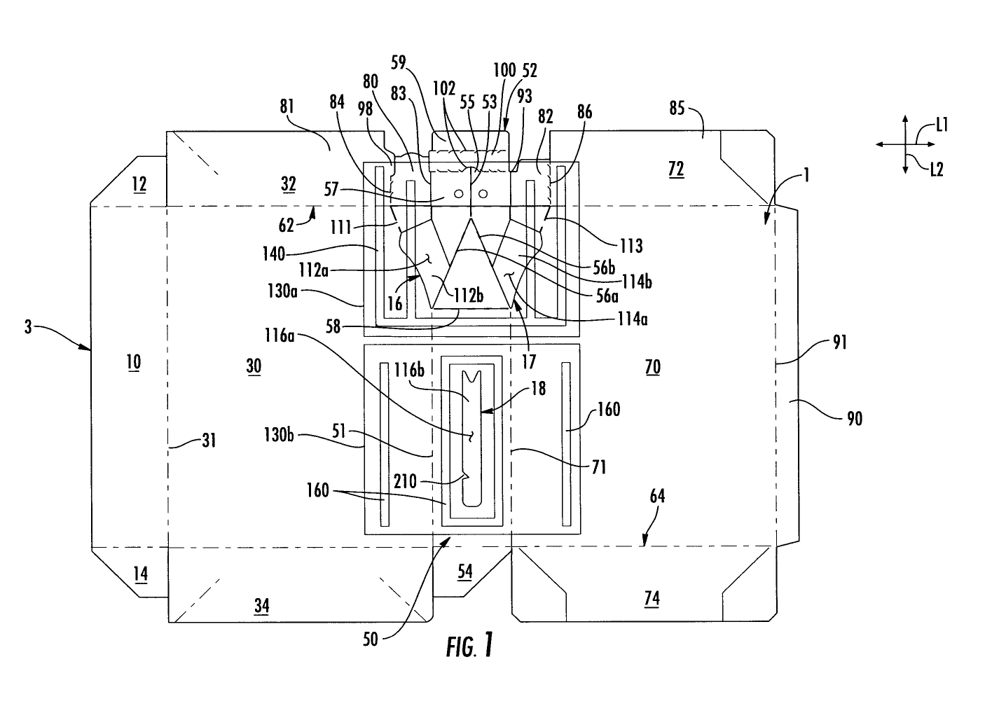

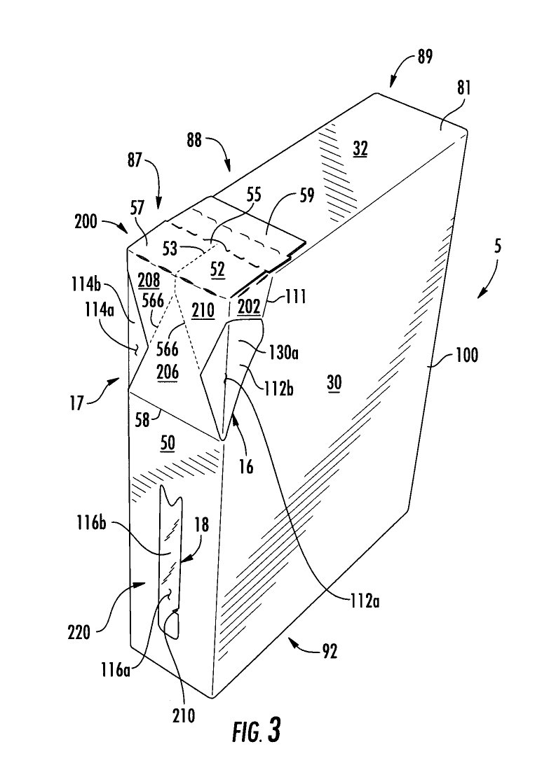

FIG. 1 is a plan view of the interior side 1 of a blank, generally indicated at 3, used to form a carton 5 (FIG. 3) according to an exemplary first embodiment of the disclosure. The carton 5 can be used to house a flowable material (not shown) or other products. In the illustrated embodiment, the carton 5 includes a dispenser, generally indicated at 200 for dispensing product from within the carton at a top end 88 of the carton. In one embodiment, the carton has a first window feature 16, a second window feature 17, and a third (e.g., indicator) window feature 18. The first and second window features 16, 17 can comprise openings 112a, 114a in the blank 3 that are covered by respective window portions 112b, 114b of an upper liner 130a. The indicator window feature 18 can comprise an opening 116a in the blank 3 that is covered by an indicator portion 116b of a lower liner 130b.

As shown in FIG. 1, the blank 3 has a longitudinal axis L1 and a lateral axis L2. In the illustrated embodiment, the blank 3 comprises a first end panel 10 foldably connected to a first side panel 30 at a first lateral fold line 31, a second end panel 50 foldably connected to the first side panel 30 at a second lateral fold line 51, and a second side panel 70 foldably connected to the second end panel 50 at a third lateral fold line 71. In the illustrated embodiment, the blank 3 includes an attachment flap 90 foldably connected to the second side panel 70 at a fourth lateral fold line 91. Alternatively, the attachment flap 90 could be foldably connected to the first end panel 10 or could be omitted without departing from the disclosure.

In the illustrated embodiment, the first end panel 10 is foldably connected to a first end top flap 12 and a first end bottom flap 14. The first side panel 30 is foldably connected to a first side top flap 32 and a first side bottom flap 34. The second end panel 50 is foldably connected to a second end top flap 52 and a second end bottom flap 54. The second side panel 70 is foldably connected to a second side top flap 72 and a second side bottom flap 74. The top flaps 12, 32, 52, and 72 extend along a first or top marginal area of the blank 3. The first end top flap 12 is foldably connected to the first end panel 10, the first side top flap 32 is foldably connected to the first side panel 30, the second end top flap 52 is foldably connected to the second end panel 50, and the second side top flap 72 is foldably connected to the second side panel 70 along a first longitudinal extending fold line 62 that extends along the length of the blank. The bottom flaps 14, 34, 54, 74 extend along a second or bottom marginal area of the blank 3. The bottom flaps 14, 34, 54, 74 are foldably connected to the respective panels 10, 30, 50, 70 along a second longitudinally extending fold line 64 that extends along the length of the blank.

In one embodiment, the longitudinal fold lines 62, 64 may be, for example, substantially straight, or offset at one or more locations to account for blank thickness or for other factors. When the carton 5 (FIG. 3) is erected, the top end flaps 12, 32, 52, 72 and close the top end 88 of the carton 5, and the bottom end flaps 14, 34, 54, 74 close a bottom end 92 of the carton 5.

As shown in FIG. 1 from the interior side 1 of the blank 3 and in FIG. 1A from the exterior side 2 of the blank 3, the first side top flap 32 includes a first portion in the form of a dispenser tab 80 that is removably connected to a second portion 81 of the first side top flap 32 along a lateral tear line 84. The dispenser tab 80 is adjacent to the second end top flap 52 and is separable from the second end top flap 52 at a cut line 83. The dispenser tab 80 is foldably connected to the first side panel 30 at the longitudinal fold line 62. The second portion 81 of the top end flap 32 comprises a protrusion 98 that can be partially formed by a cut line extending from the tear line 84. The tear line 84 could be otherwise shaped, arranged, and/or configured, or the tear line could be other forms of weakening (e.g., cut line) without departing from the disclosure.

Similarly, as shown in FIGS. 1 and 1A, the second side top flap 72 includes a first portion in the form of a dispenser tab 82 that is removably connected to a second portion 85 of the second side top flap 72 at a lateral tear line 86. The dispenser tab 82 is adjacent to the second end top flap 52 and separable from the second end top flap 52 at a cut line 93. The dispenser tab 82 is foldably connected to the second side panel 70 at the longitudinal fold line 62. The tear line 86 could be otherwise shaped, arranged, and/or configured, or the tear line could be other forms of weakening (e.g., cut line) without departing from the disclosure.

In the illustrated embodiment, the second end top flap 52 comprises a distal portion 59 that is connected to a reclosable lid portion 57 by a tear strip 100. The tear strip 100 is at least partially defined by two lateral tear lines 102 extending across the width of the end flap 52. The reclosable lid portion 57 includes a protrusion 55 that is formed by a curved cut of one of the lateral tear lines 102. The end flap 52 could be otherwise shaped arranged and configured without departing from the disclosure. Further, the tear strip 100 could be otherwise shaped, arranged, configured, and/or omitted without departing from the disclosure.

As shown in FIGS. 1 and 1A, the blank 3 can include dispensing features for forming the dispenser 200 in the carton 5 (FIGS. 3-5). The dispensing features can include the second end top flap 52, portions of the side top flaps 32, 72 that correspond with the dispenser tabs 80, 82, and the openings 112a, 114a. The dispensing features further can include a dispenser pattern, including a longitudinal fold line 58 in the second end panel 50, a lateral fold line 53 extending across the reclosable lid portion 57 of the second end top flap 52 and into the second end panel 50. The dispenser pattern of the blank 3 includes two oblique fold lines 56a, 56b extending from a respective opening 112a, 114a to the end of the lateral fold line 53 in the end panel 50. The dispenser pattern of the blank 3 further comprises oblique fold lines 111, 113 in a respective side panel 30, 70 extending from a respective opening 112a, 114a to the longitudinal fold line 62. The blank 3 could have other dispensing features or the dispensing features shown could be otherwise shaped, arranged, configured, and/or omitted without departing from the disclosure.

As shown in FIG. 1A, the dispenser features of the blank 3 that form the dispenser 200 include a dispenser panel 202 in the first side panel 30, a dispenser panel 204 in the second side panel 70, and three dispenser panels 206, 208, 210 in the second end panel 50. The dispenser panel 202 is defined by the oblique fold line 111, a portion of the lateral fold line 51, a portion of the longitudinal fold line 62, and an edge of the opening 112a. The dispenser panel 204 is defined by the oblique fold line 113, a portion of the lateral fold line 71, a portion of the longitudinal fold line 62, and an edge of the opening 114a. The dispenser panel 206 is generally triangular-shaped and is defined by the longitudinal fold line 58, oblique fold lines 56a, 56b, and respective edges of the openings 112a, 114a. The dispenser panel 208 is defined by the oblique fold line 56b, a portion of the lateral fold line 53, a portion of the longitudinal fold line 62, a portion of the lateral fold line 71, and an edge of the opening 114a. The dispenser panel 210 is defined by the oblique fold line 56a, a portion of the lateral fold line 53, a portion of the longitudinal fold line 62, a portion of the lateral fold line 51, and an edge of the opening 112a. The dispenser panels 202, 204, 206, 208, 210 could be otherwise shaped, arranged, configured, and/or omitted without departing from the disclosure.

In one embodiment, the blank 3 includes the upper patch or upper liner 130a that is adhesively attached to the blank by upper glue lines 140 or other adhesive (FIG. 1). The upper liner 130a substantially covers the dispensing features of the blank 3 including the openings 112a, 114a, dispenser panels 202, 204, 206, 208, 210, at least portions of the dispenser tabs 80, 82, and at least a portion of the second end top flap 52. As shown in FIG. 1, the window portions 112b, 114b of the upper liner 130a overlap the respective openings 112a, 114a in the second end panel 50 and the side panels 30, 70 to form the window features 16, 17. The upper glue lines 140 at least partially seal off the area around the window portions 112b, 114b of the upper liner 130a to help prevent any product in the carton 5 from exiting the carton through the window features 16, 17. In one embodiment, the upper liner 130a is a patch of color accented PVDC material, which can be viewed at the window features 16, 17 to help indicate that the carton 5 includes the upper liner 130a for helping to reduce sifting and clumping of the product when dispensing through the dispenser 200. Alternatively, the liner could comprise other suitable materials. Further, the upper liner 130a could be transparent or translucent without departing from the disclosure. Also, the upper liner 130a, could be otherwise shaped, arranged, configured, and/or omitted without departing from the disclosure.

In the embodiment of FIG. 1, the lower patch or lower liner 130b is adhesively attached to the blank 3 by lower glue lines 160 or other suitable adhesive. The indicator portion 116b of the lower liner 130b covers the opening 116a in the end panel 50 to form the indicator window feature 18. The glue lines 160 can at least partially form a seal around the indicator portion 116b of the lower liner 130b to help prevent any product in the carton 5 from exiting the carton through the indicator window feature 18. In one embodiment, the end panel 50 includes a protrusion 210 that extends into the opening 116a. The blank 3 can include indicia (not shown) that is adjacent the protrusion 210 for warning a user that the carton 5 is nearly empty when the product level is at or below the protrusion 210, for example. In one embodiment, the lower liner 130b is a clear polymeric material such as cellophane or other suitable material so that the level of product in the carton 5 can be viewed through the indicator window feature 18. The opening 116a, the indicator portion 116b of the lower liner 130b, the protrusion 210, and the optional indicia are features of the blank 3 that at least partially form an indicator 220 of the carton 5. The liner 130b could be partially transparent, translucent, or non-transparent without departing from the disclosure. Also, the lower liner 130b, could be otherwise shaped, arranged, configured, and/or omitted without departing from the disclosure.

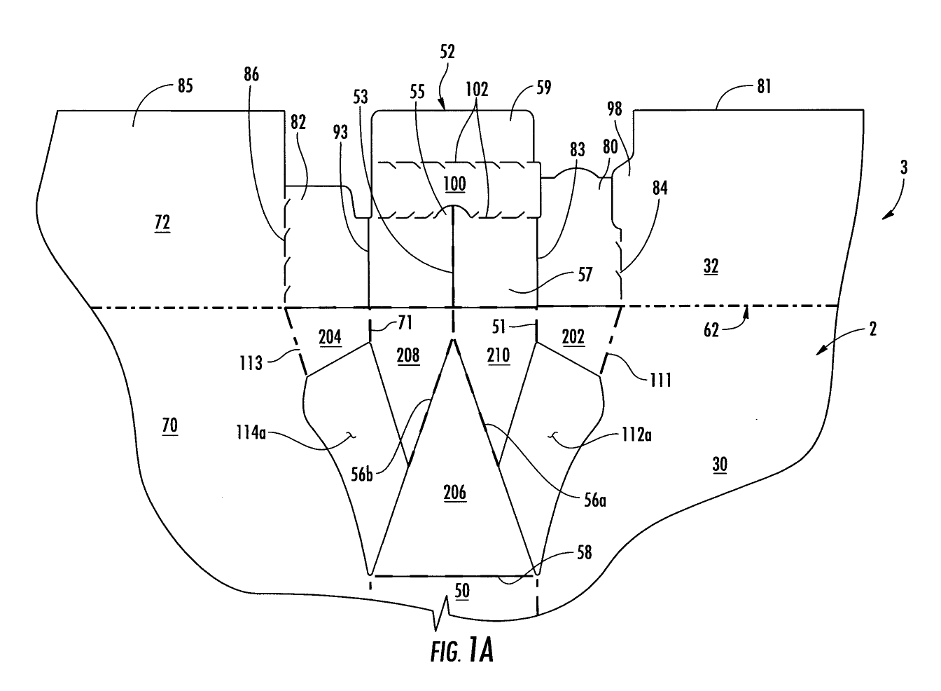

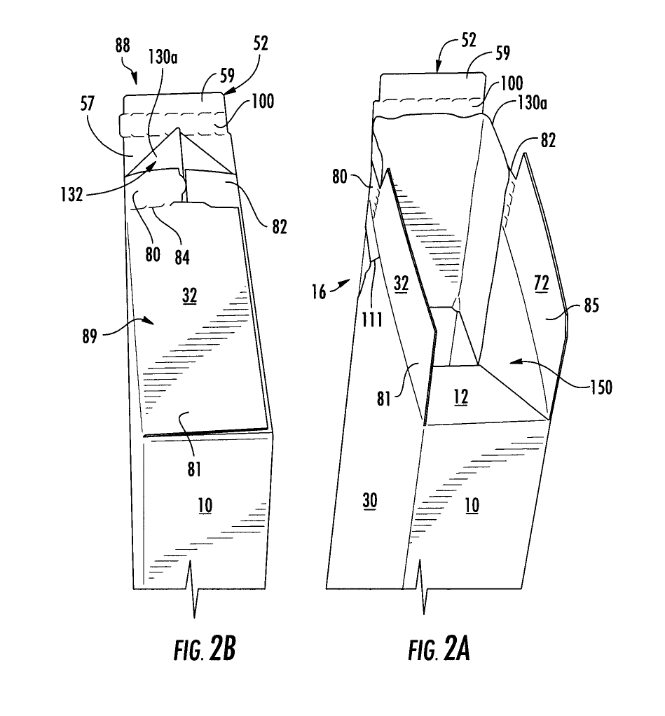

According to one exemplary method of construction, the carton 5 may be erected by folding the blank 3 about the lateral fold lines 31, 51, 71, 91 so that the attachment flap 90 is adhesively secured to or otherwise attached to the first side panel 10, and the blank 3 is formed into a generally open-ended sleeve with an interior 150 (FIG. 2A). Prior to forming the open-ended sleeve, the upper liner 130a and lower liner 130b have been attached to the blank 3 by respective glue lines or patterns 140, 160. In one embodiment the bottom of the partially erected carton 5 can be closed by folding the bottom flaps 14, 34, 54, 74 inwardly, to at least partially overlap the bottom end flaps and close the bottom end 92 of the carton 5.

A product such as a flowable material (e.g., cereal, rice, oatmeal, detergent, soap, etc.) may be placed in the interior space of the partially formed carton 5. The product can be placed in a bag or directly in the partially formed container without departing from the disclosure.

After filling the carton 5 with a product, the top 88 of the carton 5 is closed by folding and at least partially overlapping the top flaps 12, 32, 52, 72. As shown in FIG. 2B, the first side top flap 32 overlaps the second side top flap 72 with the second portion 81 of the end flap 32 being in face-to-face contact the second portion 85 of the second side top flap 72. The overlapped second portions 81, 85 of the side top flaps 32, 72 close a rear portion 89 of the top 88 of the carton (FIGS. 2B and 3). The dispenser tabs 80, 82 can be sized such that the edge margins of the dispenser taps partially overlap. Next, the second end top flap 52 is downwardly folded to fully close the top 88 of the carton 5. The erected carton 5 is shown in FIG. 3. As the side top flaps 32, 72 are folded over the top end 88, the portions of the upper liner 130a that overlap the dispenser tabs 80, 82 are also downwardly folded. Accordingly, the portions of the upper liner 130a that overlap the reclosable lid portion 57 of the second end top flap 52 are folded into a triangular shape (FIG. 2B). The configuration of the dispenser tabs 80, 82 and the reclosable lid portion 57 helps to form a gusset 132 of overlapped portions of the upper liner 130a, which can help to reduce leaking of the product through the dispenser 200, for example. The reclosable lid portion 57 of the second end top flap 52 overlaps the dispenser tabs 80, 82, and the distal portion 59 of the second end top flap 52 can be adhesively attached to or otherwise secured to the second portion 81 of the first side top flap 32. The second end top flap 52 and the dispenser tabs 80, 82 of the dispenser 200 are configured to close a front portion 87 of the top of the carton 5 (FIG. 3).

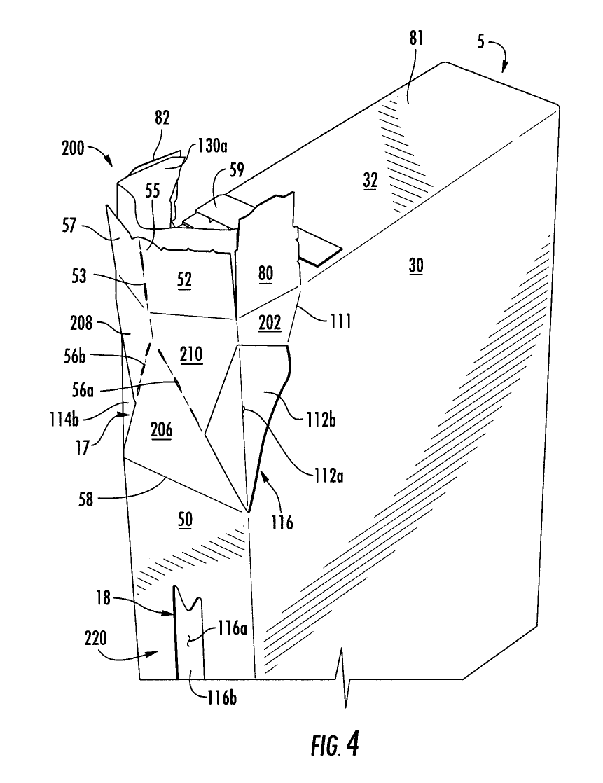

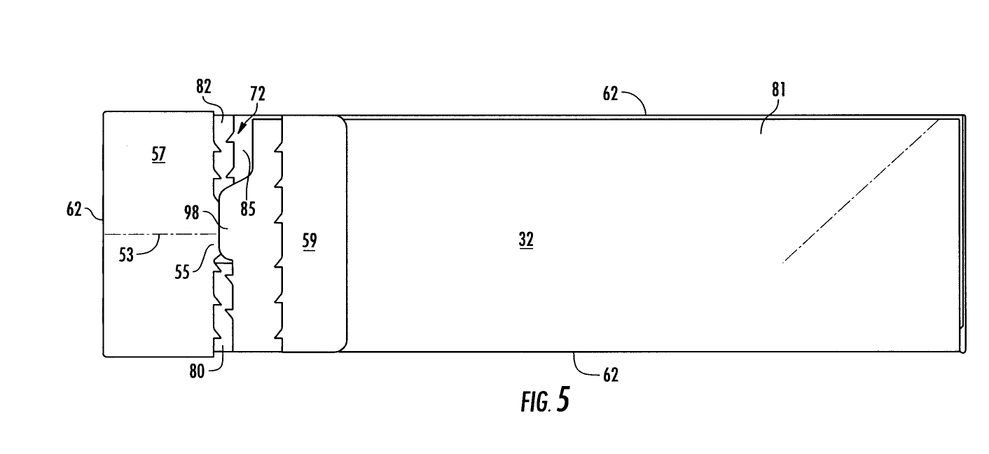

The dispenser 200 is positionable between an initially closed position (FIG. 3) and an open or dispensing position (FIG. 4) that provides access to the products held in the carton 5. Additionally, the dispenser 200 includes features that allow the dispenser to be closed (e.g., reclosed) after access to the products is no longer needed (FIG. 5). FIG. 3 illustrates the erected carton 5 with the dispenser 200 in the initially closed position, and FIG. 4 illustrates the carton 5 with the dispenser 200 being activated and opened. To activate the dispenser 200, the tear strip 100 is first torn and removed so that the reclosable lid portion 57 of the second end top flap 52 is free from attachment to the distal portion 59 of the second end top flap 52, wherein the distal portion 59 is adhesively attached to the first side top flap 32. After removing the tear strip 100, the reclosable lid portion 57 can be pivoted upward about fold line 62 allowing access to the dispenser tabs 80, 82. The dispenser tabs 80, 82 can be separated from the respective second portions 81, 85 of the respective side top flaps 32, 72 by tearing at the respective tear lines 84, 86. After separating the dispenser tabs 80, 82 from the respective second portions 81, 85 of the respective side top flaps 32, 72, the dispenser tabs 80, 82 can be upwardly folded so that the dispenser 200 is in the open or dispensing position of the carton 5 (FIG. 4). The product held in the interior 150 of the carton 5 can be poured or removed from the carton in the open or dispensing position of the dispenser 200.

As shown in FIG. 4, when the dispenser 200 is opened, the dispenser panels 202, 204, 206, 208, 210 can be flexed to position the dispenser in a position that facilitates removal of product from the carton 5. For example, the dispenser pattern can be flexed and/or squeezed to form a spout, or to otherwise help direct the product through the dispenser 200 when pouring. The dispenser panels 202, 204, 208, 210 can fold with respect to one another and with respect to the side panels 30, 70 and the end panel 50. Additionally, the reclosable lid portion 57 of the second end top flap 52 can fold along the lateral dispenser fold line 53 so that the reclosable lid portion 57 has a generally V-shaped cross-section. The upper liner 130a extends from the interior 150 of the carton 5 through the dispenser 200, overlapping the portions of the side panels 30, 70 adjacent the dispenser 200, the upper portion of the second end panel 50, and at least a portion of each of the reclosable lid portion 57 and the dispenser tabs 80, 82. Accordingly, the upper liner 130a can help guide the product from the interior 150 through the dispenser 200 as it is poured from the carton, and the upper liner can help to improve sift resistance and reduce clumping and bridging of the product in the dispenser 200.

As shown in FIG. 5, after removal of the product, the dispenser 200 can be closed by first downwardly folding the dispenser tabs 80, 82 and then downwardly folding the reclosable lid portion 57. The protrusion 55 on the reclosable lid portion 57 is sized and positioned to engage and/or interlock with the protrusion 98 of the second portion 81 of the first side top flap 32. The reclosable lid portion 57 can be retained in the reclosed position of the dispenser 200 by pressing down on the protrusion 55 such that the protrusion is forced past the protrusion 98. The protrusion 98 then overlaps and engages the protrusion 55 and helps to prevent the lid portion from being upwardly folded. Similarly to when the top end 88 is initially closed, the closing the dispenser 200 can reform the gusset 132 in the upper liner 130a. For example, as the dispenser tabs 80, 82 are folded downwardly the portions of the upper liner 130a that overlap the dispenser tabs 80, 82 are also folded downwardly, and the portions of the upper liner 130a are overlapped in a triangle shape overlapping the reclosable lid portion 57 (similar to FIG. 2B). Accordingly, the gusset 132 can help to reduce leaking of the product through the reclosed dispenser 200.

The dispenser 200 can be reopened by pushing down on the protrusion 98 to release the protrusion 55 and the reclosable lid portion 57 so that the reclosable lid portion can be upwardly folded. The dispenser tabs 80, 82 can be upwardly folded so that the dispenser 200 is configured in the dispensing position of FIG. 4.

The dispenser 200 can be opened, reclosed, and reopened by various other steps or methods other than those described herein. Further, the steps of opening, reclosing, and reopening the dispenser described herein can be modified, changed, and/or omitted without departing from the disclosure.

The level of product in the carton 5 can be monitored by viewing the indicator 220 of the carton. As product is used, the level of material will be indicated through the indicator window feature 18 in the end panel 50. The protrusion 210 can help to indicate to a user that the carton 5 is nearly empty when the material level is at or below the protrusion 210, and that more product should be purchased.

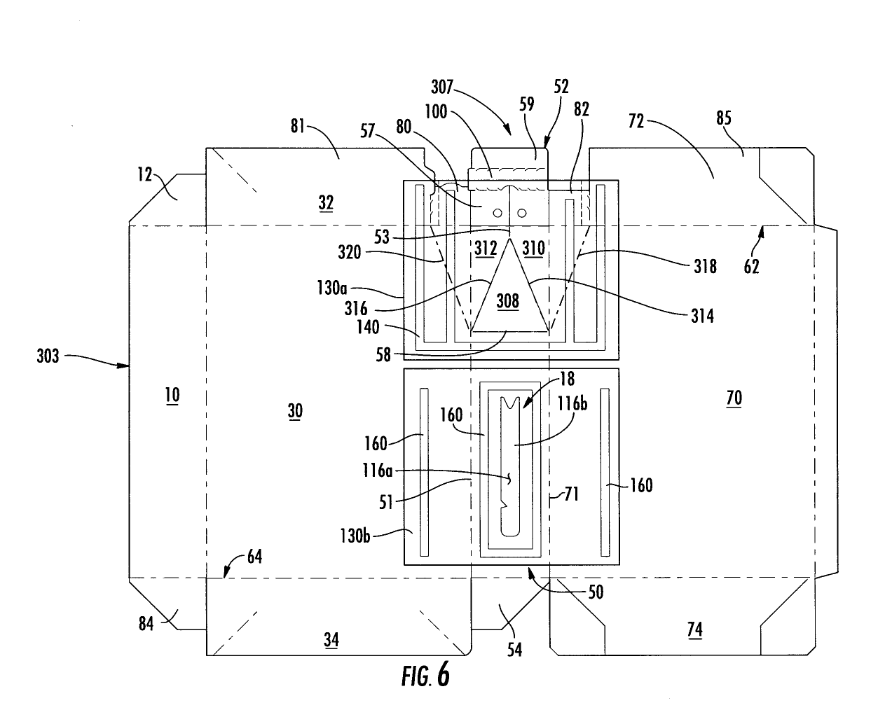

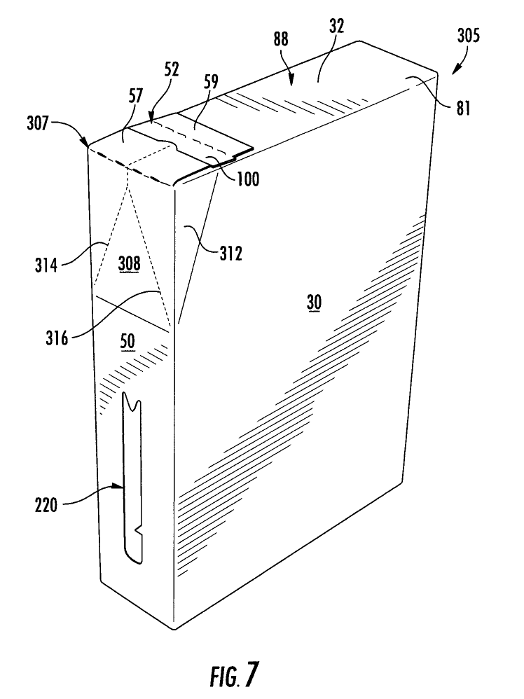

FIG. 6 illustrates a second embodiment of a blank 303 for forming a carton 305 (FIG. 7) with a dispenser 307. The second embodiment is generally similar to the first embodiment, except for variations noted and variations that will be apparent to one of ordinary skill in the art. The blank 303 of FIG. 6 has similar features as the blank 3 of the first embodiment, and like or similar reference numbers are used to indicate like or similar features. In the illustrated embodiment, the dispenser 307 has three dispenser panels 308, 310, 312 that facilitate forming the dispenser in the open position. The dispenser panel 308 is defined by the lateral fold line 58 and two oblique fold lines 314, 316. The dispenser panel 310 is defined by the oblique fold line 314, a portion of the fold line 53 in the second end panel 50, and an oblique fold line 318 extending from an end of the lateral fold line 58 to the longitudinal fold line 62 in the second side panel 70. The dispenser panel 312 is defined by the oblique fold line 316, a portion of the fold line 53 in the end panel 50, and an oblique fold line 320 extending from an end of the lateral fold line 58 to the longitudinal fold line 62 in the first side panel 30. The dispenser panel 310 comprises a portion of the end panel 50 and the second side panel 70. The dispenser panel 312 comprises a portion of the end panel 50 and the first side panel 30. As shown in FIGS. 6 and 7, the dispenser 307 can be void of any openings or windows in the blank (e.g., the window features 16, 17 of the first embodiment are omitted). The dispenser 307 could be otherwise shaped, arranged, and/or configured without departing from the disclosure.

The erected carton 305 according to the second embodiment is shown in FIG. 7. The dispenser 307 of the carton 305 can be activated, configured in an open or dispensing position, and configured in a closed position similarly to the dispenser 200 of the first embodiment. Similarly, the contents of the carton 305 can be dispensed through the dispenser 307 similarly to the first embodiment. Alternatively, the carton 305 could be otherwise shaped, arranged, and/or configured without departing from the disclosure.

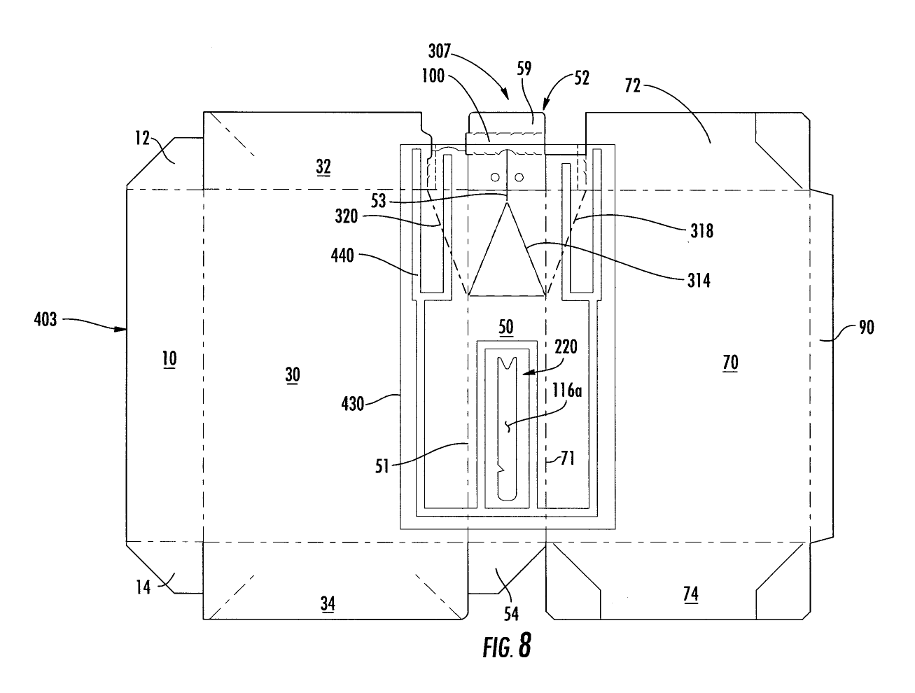

FIG. 8 illustrates a third embodiment of a blank 403 for forming a carton (not shown). The third embodiment is generally similar to the second embodiment, except for variations noted and variations that will be apparent to one of ordinary skill in the art. The blank 403 has similar features as the blank 303 of the first embodiment and the blank 303 of the second embodiment, and like or similar features are indicted with like or similar reference numbers. The blank 403 of FIG. 8 has a dispenser 307 that is similar to the dispenser of the second embodiment. The blank 403 has a single liner 430 attached to the blank 403 by a glue line 440. The glue line 440 can be a single, continuous glue line or multiple distinct glue lines. The liner 430 is sized cover the features of the dispenser 307 (similar to the upper liner 130a of the second embodiment) and the indicator opening 116a that forms the indicator 220. The blank 403 could have other features and could be otherwise shaped, arranged, and/or configured without departing form the disclosure.

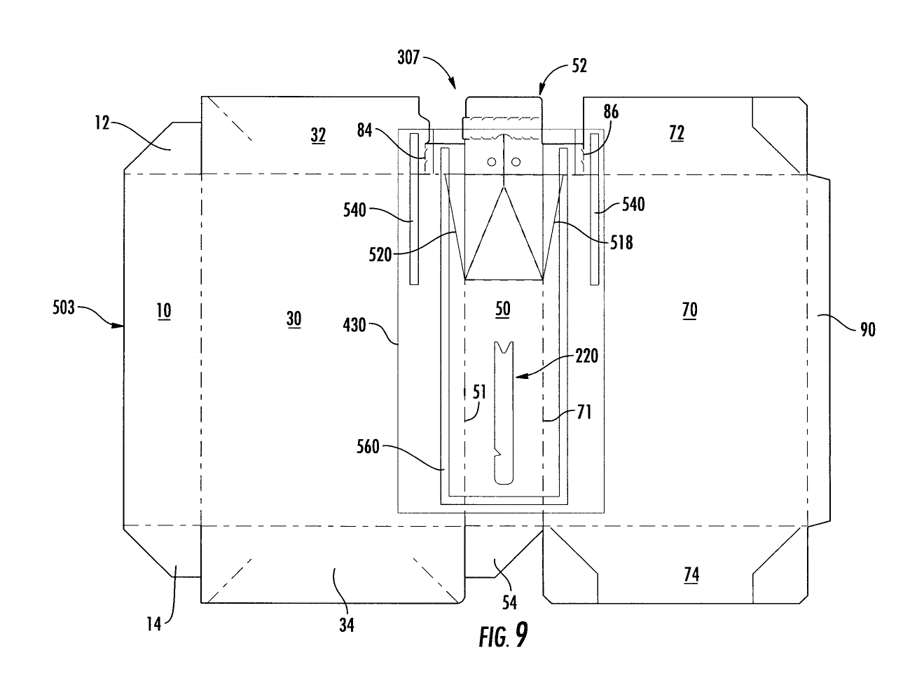

FIG. 9 illustrates fourth embodiment of a blank 503 for forming a carton (not shown) with a dispenser 507. The fourth embodiment is generally similar to the third embodiment, except for variations noted and variations that will be apparent to one of ordinary skill in the art. The blank 503 of FIG. 9 has similar features as the blank 403 of the third embodiment, and like or similar reference numbers are used to indicate like or similar features. As shown in FIG. 9, the liner 430 is secured to the blank 503 by upper glue lines 540 and an inner, U-shaped glue line 560. The dispenser 507 includes oblique dispenser fold lines 518, 520 that extend in the respective side panels 70, 30 at a steeper angle than the oblique fold lines 318, 310 in the third embodiment. Accordingly, the ends of the dispenser fold lines 518, 520 are spaced apart from the tear lines 86, 84 in the side top flaps 72, 32. The blank 503 could have other features and could be otherwise shaped, arranged, and/or configured without departing form the disclosure.

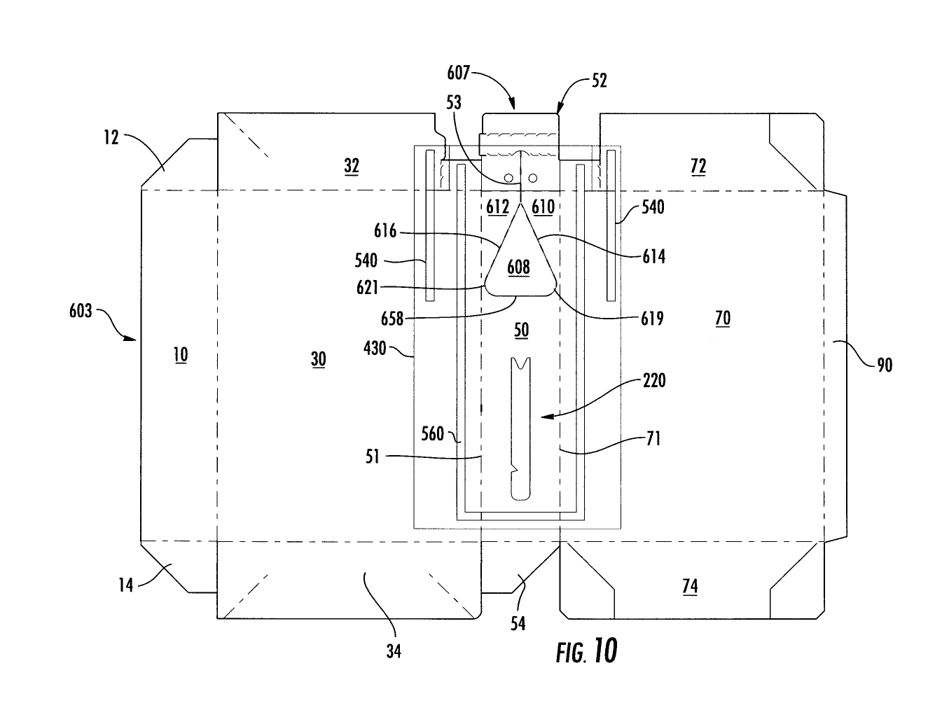

FIG. 10 illustrates fifth embodiment of a blank 603 for forming a carton with a dispenser 607. The fifth embodiment is generally similar to the fourth embodiment, except for variations noted and variations that will be apparent to one of ordinary skill in the art. The blank 603 of FIG. 10 has similar features as the blanks of the previous embodiments, and like or similar reference numbers are used to indicate like or similar features. The dispenser 607 includes three dispenser panels 608, 610, 612 that facilitate forming the dispenser in the open position. The dispenser panel 608 is defined by the lateral fold line 658 and two oblique fold lines 614, 616. The dispenser panel 610 is defined by the oblique fold line 614, a portion of the fold line 53 in the second end panel 50, and portion of the lateral fold line 71. The dispenser panel 612 is defined by the oblique fold line 616, a portion of the fold line 53 in the second end panel 50, and a portion of the lateral fold line 51. As shown in FIG. 10, the lateral fold line 658 is connected to the oblique fold lines 614, 616 at respective curved fold lines 619, 621, which can be free from connection to the lateral fold lines 51, 71. Alternatively, the fold lines 619, 621 could be otherwise positioned. The dispenser 607 could be otherwise shaped, arranged, and/or configured without departing from the disclosure.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for containing a product, the carton comprising:
a plurality of panels that extends at least partially around an interior of the carton, the plurality of panels comprises a first end panel, a first side panel, a second end panel, and a second side panel;
at least one top flap respectively foldably connected to a respective panel of the plurality of panels, the at least one top flap at least partially forming a closed top end of the carton, the at least one top flap comprising at least an end top flap foldably connected to the second end panel;
a dispenser comprising at least a portion of the end top flap, a tear feature extending at least partially across the end top flap, and a dispenser pattern extending in at least a portion of the end top flap and the second end panel, the dispenser being positionable between a dispensing position and a closed position after tearing the tear feature.

2. The carton of claim 1, further comprising a liner at least partially disposed in the interior of the carton, the liner at least partially overlapping the second end panel and the end top flap.

3. The carton of claim 2, further comprising a window feature comprising an opening in at least the second end panel and a window portion of the liner overlapping the opening.

4. The carton of claim 2, wherein:
the dispenser pattern comprises a plurality of dispenser fold lines for facilitating flexing of the dispenser when in the dispensing position; and
the plurality of dispenser fold lines comprises a lateral dispenser fold line extending in at least a portion of the end top flap and the second end panel, two oblique dispenser fold lines extending in at least the second end panel from an end of the lateral dispenser fold line, and a longitudinal dispenser fold line extending at least partially across the second end panel.

5. The carton of claim 4, wherein:
the liner overlaps at least a portion of the first side panel;
the carton further comprises a window feature comprising an opening in the second end panel and the first side panel and a window portion of the liner overlapping the opening in the second end panel and the first side panel; and
the plurality of dispenser fold lines further comprises a first side dispenser fold line extending at least partially across the first side panel from an edge of the second opening.

6. The carton of claim 5, wherein:
the window feature is a first window feature, the opening is a first opening, and the window portion of the liner is a first window portion of the liner;
the liner overlaps at least a portion of the second side panel;
the carton further comprising a second window feature comprising a second opening in the second end panel and the second side panel and a second window portion of the liner overlapping the second opening in the second end panel and the second side panel; and
the plurality of dispenser fold lines further comprises a second side dispenser fold line extending at least partially across the second side panel from an edge of the second opening.

7. The carton of claim 2, further comprising an indicator window feature comprising an indicator opening in at least one panel of the plurality of panels, wherein indicator window feature comprises an indicator portion of the liner overlapping the indicator opening.

8. The carton of claim 2, wherein:
the liner is a first liner, the first liner overlapping an upper portion of the second end panel;
the carton further comprises a second liner and an indicator window feature, the second liner being at least partially disposed in the interior of the carton and overlapping at least a lower portion of the second end panel, the indicator window feature comprising an indicator opening in at least the lower portion of the second end panel and an indicator portion of the second liner overlapping the indicator opening; and
the first liner and the second liner respectively comprise different materials.

9. The carton of claim 8, further comprising a first window feature and a second window feature, the first window feature comprising a first opening in the second end panel and the first side panel, the second window feature comprising a second opening in the second end panel and the second side panel, wherein:
the first liner overlaps at least a portion of the first side panel and at least a portion of the second side panel, the first window feature comprising a first window portion of the first liner overlapping the first opening in the second end panel and the first side panel, and the second window feature comprising a second window portion of the first liner overlapping the second opening in the second end panel and the second side panel.

10. The carton of claim 2, wherein:
the at least one top flap comprises a first side top flap foldably connected to the first side panel and a second side top flap foldably connected to the second side panel;
the dispenser comprises a first dispenser tab and a second dispenser tab, each of the first dispenser tab and the second dispenser tab comprising a first portion of the respective first side top flap and second side top flap, each of the first dispenser tab and the second dispenser tab being separable from a second portion of the respective first side top flap and second side top flap along a respective tear line; and
the liner overlaps at least a portion of the first side panel, the first dispenser tab, the second side panel, and the second dispenser tab.

11. The carton of claim 10, wherein:
the end top flap comprises a reclosable lid portion and a distal portion, the reclosable lid portion overlapping at least a portion of the first dispenser tab and the second dispenser tab, and the distal portion being secured to the second portion of at least one of the first side top flap and the second side top flap; and
the tear feature comprises a tear strip, the distal portion being separable from the reclosable lid portion along the tear strip.

12. The carton of claim 1, wherein:
the at least one top flap further comprises a side top flap foldably connected to the first side panel, at least a portion of the end top flap at least partially overlapping the side top flap to at least partially form the closed top end of the carton; and
the end top flap comprises a reclosable lid portion and a distal portion, the distal portion being at least partially in face-to-face contact with the side top flap.

13. The carton of claim 12, wherein:
the dispenser comprises a dispenser tab, the dispenser tab comprising a first portion of the side top flap and being separable from a second portion of the side top flap along a tear line; and
at least a portion of the reclosable lid portion of the end top flap at least partially overlaps the dispenser tab, and at least a portion of the distal portion is secured to at least a portion of the second portion of the side top flap.

14. The carton of claim 13, wherein:
the tear feature comprises a tear strip, the reclosable lid being separable from the distal portion along the tear strip; and
the reclosable lid portion comprises a protrusion at least partially defined by the tear strip, the protrusion being at least partially overlapped by at least a portion of the side top flap when the dispenser is in the closed position.

15. The carton of claim 13, wherein the dispenser pattern comprises a plurality of dispenser fold lines for facilitating flexing of the dispenser when in the dispensing position, the plurality of dispenser fold lines comprising a lateral dispenser fold line extending at least partially across the reclosable lid portion of the end top flap and the second end panel, a first oblique dispenser fold line and a second oblique dispenser fold line extending in at least the second end panel from an end of the lateral dispenser fold line, and a longitudinal dispenser fold line extending at least partially across the second end panel.

16. The carton of claim 15, wherein:
the side top flap is a first side top flap, the at least one top flap further comprising a second side top flap foldably connected to the second side panel;
the dispenser tab is a first dispenser tab and the tear line is a first tear line, the dispenser further comprising a second dispenser tab that is separable from a second portion of the second side top flap along a second tear line; and
the plurality of dispenser fold lines comprises a first side dispenser fold line extending in the first side panel from an end of the first tear line and a second side dispenser fold line extending in the second side panel from an end of the second tear line.

17. The carton of claim 16, wherein the first side dispenser fold line and the first oblique dispenser fold line extend from a first end of the longitudinal dispenser fold line, and the second side dispenser fold line and the second oblique dispenser fold line extend from a second end of the longitudinal dispenser fold line.

18. The carton of claim 15, wherein the plurality of dispenser fold lines comprises a first curved dispenser fold line and a second curved dispenser fold line, the first curved dispenser fold line extending in the second end panel from an end of the first oblique dispenser fold line to a first end of the longitudinal dispenser fold line, and the second curved dispenser fold line extending in the second end panel from an end of the second oblique dispenser fold line to a second end of the longitudinal dispenser fold line.

19. The carton of claim 13, further comprising a liner overlapping at least a portion of the reclosable lid portion of the end top flap, the dispenser tab, the second end panel, and the first side panel.

20. The carton of claim 19, wherein the liner comprises at least a first edge and a second edge, at least a portion of the first edge at least partially overlapping the dispenser tab and the first side panel, at least a portion of the second edge at least partially overlapping the first side panel and the second end panel.

21. A blank for forming carton for containing a product, the blank comprising:
a plurality of panels comprising a first end panel, a first side panel, a second end panel, and a second side panel;
at least one top flap respectively foldably connected to a respective panel of the plurality of panels, the at least one top flap being for at least partially forming a closed top end of the carton formed from the blank, the at least one top flap comprising at least an end top flap foldably connected to the second end panel; and
dispenser features for forming a dispenser in the carton formed from the blank, the dispenser features comprising at least a portion of the end top flap, a tear feature extending at least partially across the end top flap, and a dispenser pattern extending in at least a portion of the end top flap and the second end panel, the dispenser being for positioning between a dispensing position and a closed position after tearing the tear feature in the carton formed from the blank.

22. The blank of claim 21, further comprising a liner at least partially overlapping an interior surface of the second end panel and the end top flap.

23. The blank of claim 22, further comprising a window feature comprising an opening in at least the second end panel and a window portion of the liner overlapping the opening.

24. The blank of claim 22, wherein:
the dispenser pattern comprises a plurality of dispenser fold lines for facilitating flexing of the dispenser when in the dispensing position in the carton formed from the blank; and
the plurality of dispenser fold lines comprises a lateral dispenser fold line extending in at least a portion of the end top flap and the second end panel, two oblique dispenser fold lines extending in at least the second end panel from an end of the lateral dispenser fold line, and a longitudinal dispenser fold line extending at least partially across the second end panel.

25. The blank of claim 24, wherein:
the liner overlaps at least a portion of the first side panel;
the blank further comprises a window feature comprising an opening in the second end panel and the first side panel and a window portion of the liner overlapping the opening in the second end panel and the first side panel; and
the plurality of dispenser fold lines further comprises a first side dispenser fold line extending at least partially across the first side panel from an edge of the second opening.

26. The blank of claim 25, wherein:
the window feature is a first window feature, the opening is a first opening, and the window portion of the liner is a first window portion of the liner;
the liner overlaps at least a portion of the second side panel;
the carton further comprises a second window feature comprising a second opening in the second end panel and the second side panel and a second window portion of the liner overlapping the second opening in the second end panel and the second side panel; and
the plurality of dispenser fold lines further comprises a second side dispenser fold line extending at least partially across the second side panel from an edge of the second opening.

27. The blank of claim 22, further comprising an indicator window feature comprising an indicator opening in at least one panel of the plurality of panels, wherein indicator window feature comprises an indicator portion of the liner overlapping the indicator opening.

28. The blank of claim 22, wherein:
the liner is a first liner, the first liner overlapping an upper portion of the second end panel;
the blank further comprises a second liner and an indicator window feature, the second liner overlapping at least a lower portion of the interior surface of the second end panel, the indicator window feature comprising an indicator opening in at least the lower portion of the second end panel and an indicator portion of the second liner overlapping the indicator opening; and
the first liner and the second liner respectively comprise different materials.

29. The blank of claim 28, further comprising a first window feature and a second window feature, the first window feature comprising a first opening in the second end panel and the first side panel, the second window feature comprising a second opening in the second end panel and the second side panel, wherein:
the first liner overlaps at least a portion of the first side panel and at least a portion of the second side panel, the first window feature comprising a first window portion of the first liner overlapping the first opening in the second end panel and the first side panel, and the second window feature comprising a second window portion of the first liner overlapping the second opening in the second end panel and the second side panel.

30. The blank of claim 22, wherein:
the at least one top flap comprises a first side top flap foldably connected to the first side panel and a second side top flap foldably connected to the second side panel;
the dispenser comprises a first dispenser tab and a second dispenser tab, each of the first dispenser tab and the second dispenser tab comprising a first portion of the respective first side top flap and second side top flap, each of the first dispenser tab and the second dispenser tab being separable from a second portion of the respective first side top flap and second side top flap along a respective tear line; and
the liner overlaps at least a portion of the first side panel, the first dispenser tab, the second side panel, and the second dispenser tab.

31. The blank of claim 30, wherein:
the end top flap comprises a reclosable lid portion and a distal portion, the reclosable lid portion being for overlapping at least a portion of the first dispenser tab and the second dispenser tab in the carton formed from the blank, and the distal portion is for being secured to the second portion of at least one of the first side top flap and the second side top flap in the carton formed from the blank; and
the tear feature comprises a tear strip, the distal portion being separable from the reclosable lid portion along the tear strip.

32. The blank of claim 21, wherein:
the at least one top flap further comprises a side top flap foldably connected to the first side panel, at least a portion of the end top flap being for at least partially overlapping the side top flap to at least partially form the closed top end of the carton formed from the blank; and
the end top flap comprises a reclosable lid portion and a distal portion, the distal portion for being disposed at least partially in face-to-face contact with the side top flap.

33. The blank of claim 32, wherein:
the dispenser comprises a dispenser tab, the dispenser tab comprising a first portion of the side top flap and being separable from a second portion of the side top flap along a tear line; and
at least a portion of the reclosable lid portion of the end top flap is for at least partially overlapping the dispenser tab in the carton formed from the blank, and at least a portion of the distal portion is for being secured to at least a portion of the second portion of the side top flap in the carton formed from the blank.

34. The blank of claim 33, wherein:
the tear feature comprises a tear strip, the reclosable lid being separable from the distal portion along the tear strip; and
the reclosable lid portion comprises a protrusion at least partially defined by the tear strip, the protrusion is for being at least partially overlapped by at least a portion of the side top flap when the dispenser is in the closed position in the carton formed from the blank.

35. The blank of claim 33, wherein the dispenser pattern comprises a plurality of dispenser fold lines for facilitating flexing of the dispenser when in the dispensing position in the carton formed from the blank, the plurality of dispenser fold lines comprising a lateral dispenser fold line extending at least partially across the reclosable lid portion of the end top flap and the second end panel, a first oblique dispenser fold line and a second oblique dispenser fold line extending in at least the second end panel from an end of the lateral dispenser fold line, and a longitudinal dispenser fold line extending at least partially across the second end panel.

36. The blank of claim 35, wherein:
the side top flap is a first side top flap, the at least one top flap further comprising a second side top flap foldably connected to the second side panel;
the dispenser tab is a first dispenser tab and the tear line is a first tear line, the dispenser further comprising a second dispenser tab that is separable from a second portion of the second side top flap along a second tear line; and
the plurality of dispenser fold lines comprises a first side dispenser fold line extending in the first side panel from an end of the first tear line and a second side dispenser fold line extending in the second side panel from an end of the second tear line.

37. The blank of claim 36, wherein the first side dispenser fold line and the first oblique dispenser fold line extend from a first end of the longitudinal dispenser fold line, and the second side dispenser fold line and the second oblique dispenser fold line extend from a second end of the longitudinal dispenser fold line.

38. The blank of claim 35, wherein the plurality of dispenser fold lines comprises a first curved dispenser fold line and a second curved dispenser fold line, the first curved dispenser fold line extending in the second end panel from an end of the first oblique dispenser fold line to a first end of the longitudinal dispenser fold line, and the second curved dispenser fold line extending in the second end panel from an end of the second oblique dispenser fold line to a second end of the longitudinal dispenser fold line.

39. The blank of claim 33, further comprising a liner overlapping at least a portion of the reclosable lid portion of the end top flap, the dispenser tab, the second end panel, and the first side panel.

40. The blank of claim 39, wherein the liner comprises at least a first edge and a second edge, at least a portion of the first edge at least partially overlapping the dispenser tab and the first side panel, and at least a portion of the second edge at least partially overlapping the first side panel and the second end panel.

41. A method of forming a carton, the method comprising:
obtaining a blank comprising a plurality of panels comprising a first end panel, a first side panel, a second end panel, and a second side panel, at least one top flap respectively foldably connected to a respective panel of the plurality of panels, the at least one top flap comprising at least an end top flap foldably connected to the second end panel, and dispenser features comprising at least a portion of the end top flap, a tear feature extending at least partially across the end top flap, and a dispenser pattern extending in at least a portion of the end top flap and the first end panel;
forming an interior of the carton at least partially defined by the plurality of panels;
positioning the at least one top flap to at least partially close a top end of the interior and to at least partially form a dispenser comprising the dispenser features;
opening the dispenser by tearing the tear feature and positioning a reclosable lid portion of the end top flap to a dispensing position; and
closing the dispenser by positioning the reclosable lid portion of the end top flap to a closed position.

42. The method of claim 41, further comprising positioning a liner to at least partially overlap an interior surface of the second end panel and the end top flap.

43. The method of claim 42, further comprising forming a window feature comprising an opening in at least the second end panel and a window portion of the liner by overlapping the window portion of the liner with the opening in at least the second end panel.

44. The method of claim 42, wherein:
the at least one top flap comprises a first side top flap foldably connected to the first side panel and a second side top flap foldably connected to the second side panel;
the dispenser features comprise a first dispenser tab and a second dispenser tab, each of the first dispenser tab and the second dispenser tab comprising a first portion of the respective first side top flap and second side top flap, each of the first dispenser tab and the second dispenser tab being separable from a second portion of the respective first side top flap and second side top flap along a respective tear line;
the end top flap further comprises a distal portion and the tear feature comprises a tear strip, the distal portion being separable from the reclosable lid portion along the tear strip;
the positioning the at least one top flap comprises positioning the end top flap so that the reclosable lid portion overlaps at least a portion of the first dispenser tab and the second dispenser tab and securing the distal portion to the second portion of at least one of the first side top flap and the second side top flap; and
the opening the dispenser comprising at least partially removing the tear strip to separate the distal portion and the reclosable lid portion of the end top flap, pivoting the reclosable lid portion upwardly, separating the first dispenser tab and the second dispenser tab from the respective second portion of the respective first side top flap and second side top flap along the respective tear lines, and pivoting the first dispenser tab and the second dispenser tab upwardly.

45. The method of claim 44, wherein:
the reclosable lid portion comprises a protrusion at least partially defined in an edge of the reclosable lid portion formed by the removing of the tear strip;
the closing the dispenser comprising pivoting the first dispenser tab and the second dispenser tab downwardly, pivoting the reclosable lid portion downwardly, and engaging at least a portion of the protrusion with at least a portion of the second portion of at least one of the first side top flap or the second side top flap.

46. The method of claim 41, wherein:
the dispenser pattern comprises a lateral dispenser fold line extending in at least a portion of the end top flap and the second end panel, two oblique dispenser fold lines extending in at least the second end panel from an end of the lateral dispenser fold line, and a longitudinal dispenser fold line extending at least partially across the second end panel; and
the method further comprises flexing the dispenser at least the dispenser pattern after the opening the dispenser.
